(19) United States
(12) Patent Application Publication
(10) Pub. No.: US 2014/0144739 A1
(43) Pub. Date: May 29, 2014

(54) Brake Spider and Cam Bearing Support

(71) Applicant: SAF-HOLLAND, Inc., Holland, MI (US)

(72) Inventors: Gregory T. Galazin, Muskegon, MI (US); Roger Jansen, III, Holton, MI (US)

(73) Assignee: SAF-HOLLAND, Inc., Holland, MI (US)

(21) Appl. No.: 14/089,110

(22) Filed: Nov. 25, 2013

Related U.S. Application Data
(60) Provisional application No. 61/731,230, filed on Nov. 29, 2012.

(51) Int. Cl. F16D 51/22; B60T 1/06; F16D 65/40; F16D 65/09; F16D 65/22

(52) U.S. Cl. CPC F16D 51/22; F16D 65/09; F16D 65/22; F16D 65/40; B60T 1/067
USPC 188/330; 188/206 A

(57) ABSTRACT

A vehicle brake assembly including a brake element which is movable between a first position, wherein the brake element is closed, and a second position, wherein the brake element is open, an actuator shaft having an actuator located along the length thereof and adapted to actuate the brake element from the first position to the second position, and an integral, single-piece brake spider that includes a first portion operably coupled with an axle, a second portion operably coupled to the brake element and a third portion that receives the actuator shaft therein, wherein the third portion extends along a majority of the length of the actuator shaft.

### BACKGROUND OF THE INVENTION

The present invention relates to a vehicle brake assembly, in particular to a single, integral single-piece brake spider.

### BRIEF SUMMARY OF THE INVENTION

One aspect of the present invention is to provide a vehicle brake assembly that comprises a brake element moveable between a first position, wherein the brake element is closed, and a second position, wherein the brake element is open. The brake assembly further includes an actuator shaft having an actuator located along a length thereof and adapted to actuate the brake element from the first position to the second position. The vehicle brake assembly further comprises an integral, single piece brake spider that includes a first portion adapted to operably couple with an axle, a second portion operably coupled to the brake element, and a third portion that receives the actuator shaft therein, wherein the third portion extends along a majority of the length of the actuator shaft.

Another aspect of the present invention is to provide a vehicle brake assembly that comprises an axle, a spindle operably coupled with the axle, a brake element moveable between a first position, wherein the brake element is closed, and a second position, wherein the brake element is open. The axle assembly also comprises an actuator shaft having an actuator located along a length thereof that actuates the brake element from the first position to the second position, and an integral, single piece brake spider comprising a first portion coupled to the axle, a second portion operably coupled to the brake element, and a third portion that receives the actuator shaft therein, wherein the third portion extends along a majority of the length of the actuator shaft.

Yet another aspect of the present invention is to provide a brake spider that comprises a first portion having a first aperture for receiving an axle therethrough, a second portion that includes at least one second aperture for mounting the brake spider to a brake element, and a third portion that includes an elongated shaft enclosure adapted to receive a brake actuator shaft therein, wherein the first, second, and third portions comprise an integral, single piece, and wherein the third portion is adapted to extend along a majority of a length of the brake actuator shaft.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a top perspective view of the vehicle brake assembly of the present invention;

FIG. 2 is an exploded top perspective view of the vehicle brake assembly of the present invention;

FIG. 3 is a side elevational view of the integral, single-piece brake spider of the vehicle brake assembly; and

FIG. 4 is a side elevational view of the integral, single-piece brake spider assembly of the present invention.

### DETAILED DESCRIPTION

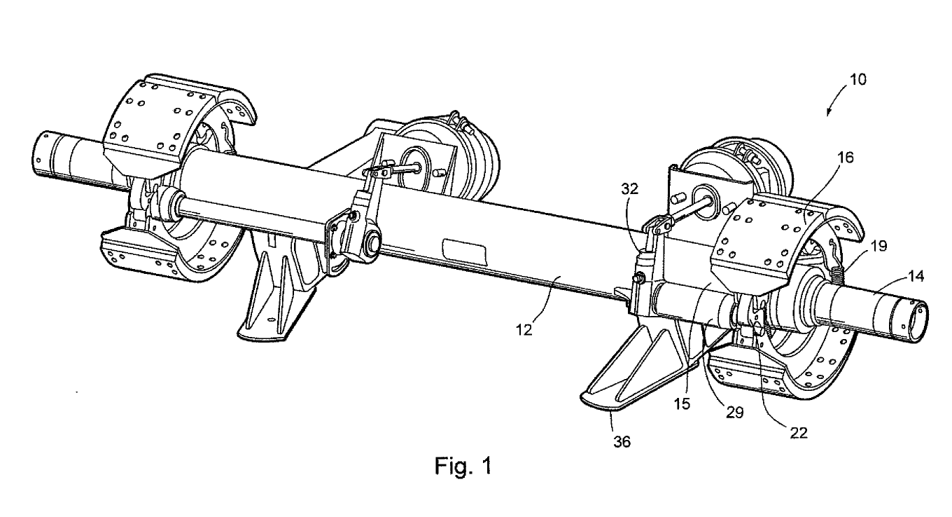

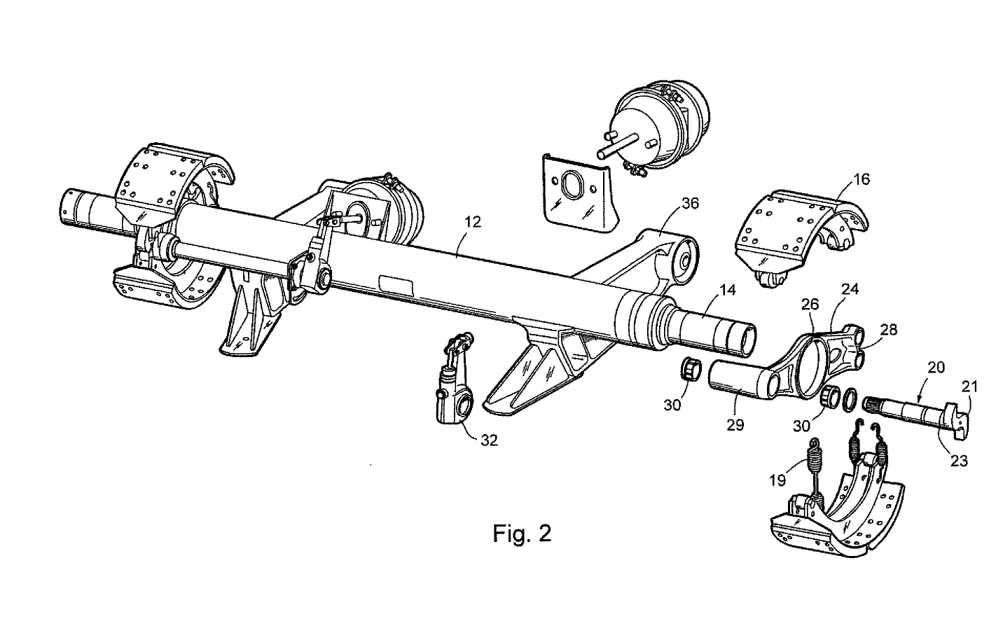

For purposes of description herein, the terms “upper,” “lower,” “right,” “left,” “rear,” “front,” “vertical,” “horizontal,” “top,” “bottom,” and derivatives thereof shall relate to the invention as shown in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions, proportions, and other physical characteristics relating to the embodiment disclosed herein are not to be considered as limiting, unless the claims expressly state otherwise.

The reference numeral 10 (FIG. 1) generally designates a vehicle brake assembly which includes an axle 12 with a spindle 14 positioned on a distal end of the axle. A two-piece brake element 16 is pivotably coupled to the spindle 14 and biased by a pair of coil springs 19. While the present illustrated example includes brake shoe assemblies as the brake elements 16 other suitable brake arrangements may also be utilized. The coil springs 19 bias the brake element 16 towards a first position, wherein the brake element 16 is defined as closed, from a second position, wherein the brake element 16 is open. Specifically, the brake element 16 is closed when both pieces of the brake element 16 are not in contact with or spaced from a brake drum (not shown). The brake element 16 is defined as open when the two pieces of the brake element 16 separate from one another and abut the surface of a brake drum or other braking mechanism. At an extreme, the second position is defined as the brake element 16 abutting the surface of the brake drum.

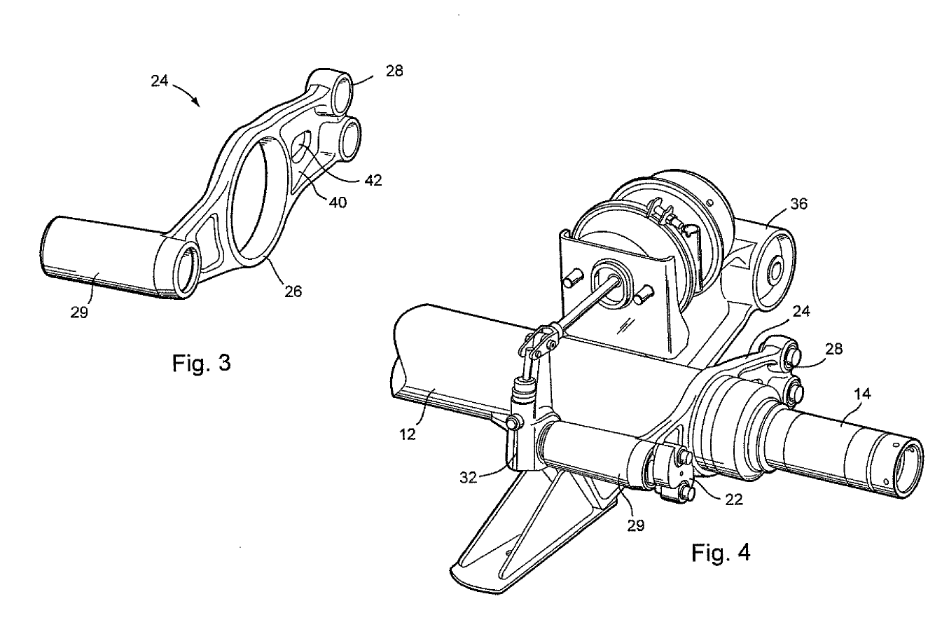

An actuator shaft 20 is located proximate the brake element 16 and includes an actuator 21 preferably in the form of an S-cam actuator which is located on a distal end 23, of the actuator shaft 20. The actuator 21 actuates the brake element 16 from the first or closed position to the second or open position when the actuator 21 is rotated. An integral, single-piece brake spider 24 operably engages the spindle 14. The brake spider 24 includes a first portion 26 which is adapted to be rotatably coupled about the axle 12. Specifically, and as best illustrated in FIGS. 3 and 4, the first portion of the brake spider 26 is operably coupled with the axle 14. Specifically, the first portion 26 comprises an aperture that receives the axle 12 therethrough. In the illustrated example, the first portion 26 further includes recesses 40 and apertures 42 spaced about a length thereof, thereby reducing the overall weight of the brake spider 24. A second portion 28 of the brake spider 24 is coupled with the brake element 16. The second portion 28 is operably coupled or mounted to the brake element 16, and includes multiple annular segments oriented tangentially to which the brake element 16 are pivotably coupled. A third portion 29 of the brake spider 24 includes an elongated shaft enclosure 29 that encloses the actuator shaft 20. The third portion 29 includes an elongated shaft enclosure which completely encloses the actuator shaft 20. Specifically, the shaft enclosure prevents dirt and debris from contaminating the actuator shaft 20 by extending along nearly the entire length of the actuator shaft 20. The vehicle brake assembly 10 also includes a pair of bearings 30 that mount the actuator shaft 20 within the shaft enclosure.

A slack adjuster assembly 32 is located proximate the spindle 14 and is operably connected to the actuator shaft 20. The slack adjuster 32 functions to offset the wear that occurs on the outside of the brake element 16 in a manner known in the art. In general, the slack adjuster assembly 32 is adjustable in length, thereby allowing for wear of the brake elements 16 and the length of actuation necessary to move the brake elements in the open and closed positions.

The present inventive brake assembly is efficient in manufacturing, assembly, and use, may be quickly assembled, is economical to manufacture, capable of a long operating life, and is particularly well adapted for the proposed use.

The above description is considered that of the preferred embodiments only. Modifications of the inventions will occur to those skilled in the art and to those who make or use the invention. The various devices and methods of providing user information described herein may also be used in combination or separately. Therefore it is understood that the embodiments shown in the drawings and described above is merely for illustrative purposes and not intended to limit the scope of the invention.

What is claimed is:

1. A vehicle brake assembly, comprising:
a brake element moveable between a first position, wherein the brake element is closed and a second position, wherein the brake element is open;
an actuator shaft having an actuator located along a length thereof and adapted to actuate the brake element from the first position to the second position; and
an integral, single-piece brake spider comprising:
a first portion adapted to operably couple with an axle;
a second portion operably coupled to the brake element; and
a third portion that receives the actuator shaft therein, wherein the third portion extends along a majority of the length of the actuator shaft.

2. The vehicle brake assembly of claim 1, further comprising:
a slack adjuster operably coupled to the actuator shaft.

3. The vehicle brake assembly of claim 2, wherein the third portion of the brake spider extends to the slack adjuster.

4. The vehicle brake assembly of claim 1, wherein the third portion of the brake spider prevents debris from contacting at least a portion of the length of the actuator shaft.

5. The vehicle brake assembly of claim 1, wherein the brake element includes a biasing member which biases the brake element towards the first position.

6. The vehicle brake assembly of claim 5, wherein the biasing member includes a coil spring.

7. The vehicle brake assembly of claim 1, wherein the first portion of the brake spider includes an aperture for receiving an axle.

8. The vehicle brake assembly of claim 1, wherein the second portion of the brake spider includes at least one aperture to which the brake element is coupled.

9. The vehicle brake assembly of claim 1, further comprising:
at least one bearing assembly pivotably supporting the actuator shaft from the third portion of the brake spider.

10. A vehicle brake assembly, comprising:
an axle;
a spindle operably coupled with the axle;
a brake element moveable between a first position, wherein the brake element is closed, and a second position, wherein the brake element is open;
an actuator shaft including an actuator located along a length thereof and that actuates the brake element from the first position to the second position; and
an integral, single-piece brake spider comprising:
a first portion coupled to the axle;
a second portion operably coupled to the brake element; and
a third portion that receives the actuator shaft therein, wherein the third portion extends along a majority of the length of the actuator shaft.

11. The vehicle brake assembly of claim 10, further comprising:
a slack adjuster operably coupled to the actuator shaft.

12. The vehicle brake assembly of claim 11, wherein the third portion of the brake spider prevents debris from contacting at least a portion of the length of the actuator shaft.

13. The vehicle brake assembly of claim 10, wherein the brake element includes a biasing member which biases the brake element towards the first position.

14. The axle assembly of claim 13, wherein the biasing element includes a coil spring.

15. The vehicle brake assembly of claim 10, wherein the first portion of the brake spider includes an aperture that receives the axle therethrough.

16. The vehicle brake assembly of claim 10, wherein the second portion of the brake spider includes at least one aperture to which the brake element is coupled.

17. The vehicle brake assembly of claim 10, further comprising:
at least one bearing assembly pivotally supporting the actuator shaft from the third portion.

18. The vehicle brake assembly of claim 10, wherein the third portion of the brake spider prevents debris from contacting the at least a portion of the actuator shaft.

19. A brake spider comprising:
a first portion that includes a first aperture for receiving an axle therethrough;
a second portion that includes at least one second aperture for mounting the brake spider to a brake element; and
a third portion that includes an elongated shaft enclosure adapted to receive a brake actuator shaft therein, wherein the first, second, and third portions comprise an integral, single-piece, and wherein the third portion is adapted to extend along a majority of a length of the brake actuator shaft.

20. The brake spider of claim 17, wherein the at least one second aperture includes a pair of second apertures vertically aligned with one another.
